(19) United States
(12) Patent Application Publication
(10) Pub. No.: US 2024/0377363 A1
(43) Pub. Date: Nov. 14, 2024

(54) NON-DESTRUCTIVE INSPECTION ADAPTABLE HEAD FOR MULTIPLE PROFILES

(71) Applicant: Evident Canada, Inc., Québec (CA)

(72) Inventors: Justin Trachy-Cloutier, Lévis (CA); Christian Gagnon-Lachance, Lévis (CA)

(21) Appl. No.: 18/691,773

(22) PCT Filed: Sep. 16, 2022
(86) PCT No.: PCT/CA2022/051378

§ 371 Date: Mar. 13, 2024

Related U.S. Application Data
(60) Provisional application No. 63/261,327, filed on Sep. 17, 2021.

(51) Int. Cl. G01N 29/265; G01N 27/9013; G01N 29/24; G01N 29/27; G01N 29/28

(52) U.S. Cl. CPC G01N 29/265; G01N 27/902; G01N 29/24; G01N 29/27; G01N 29/28; G01N 2291/2626

(57) ABSTRACT

An adaptable inspection fixture configuration can be used to support Non-Destructive Test (NDT). Such adaptability can include use of two or more separate inspection probe assemblies. along with multiple available mechanical degrees of freedom to permit inspection of a variety of different cross-sectional profiles for inspection of bar or other structures.

### CLAIM OF PRIORITY

This application claims priority to U.S. Provisional Application Ser. No. 63/261,327, filed on Sep. 17, 2021, which is incorporated by reference herein in its entirety, and the benefit of priority of which is claimed herein.

### FIELD OF THE DISCLOSURE

This document pertains generally, but not by way of limitation, to apparatus and techniques for non-destructive inspection such as facilitating eddy-current or acoustic inspection, and more particularly, to mechanical fixturing that is adaptable to different material profiles, such as bar or rail structures that can vary in one or more of size, shape, orientation, or curvature, along their length.

### BACKGROUND

Non-destructive testing (NDT) can refer to use of one or more different techniques to inspect regions on or within an object, such as to ascertain whether flaws or defects exist, or to otherwise characterize the object being inspected. Examples of non-destructive test approaches can include use of an eddy-current testing approach where electromagnetic energy is applied to the object and resulting induced currents on or within the object are detected, with the values of a detected current (or a related impedance) providing an indication of the structure of the object under test, such as to indicate a presence of a crack, void, porosity, or other inhomogeneity.

Another approach for NDT can include use of an acoustic inspection technique, such as where one or more electroacoustic transducers are used to insonify a region on or within the object under test, and acoustic energy that is scattered or reflected can be detected and processed. Such scattered or reflected energy can be referred to as an acoustic echo signal. Generally, such an acoustic inspection scheme involves use of acoustic frequencies in an ultrasonic range of frequencies, such as including pulses having energy in a specified range that can include value from, for example, a few hundred kilohertz, to tens of megahertz, as an illustrative example.

### SUMMARY

The present subject matter generally involves apparatus and techniques that can facilitate non-destructive testing (NDT), such as involving eddy-current, or acoustic inspection techniques. For example, an acoustic technique can include use of phased-array (PA) or single element acoustic transducer structures. Acoustic inspection may employ a couplant to facilitate coupling of acoustic energy between a transducer and an object under test. In one approach, an ultrasonic coupling medium, such as water, can be provided, such as in a laminar fashion interposed between a surface of a probe and a test object. In another approach, an acoustic coupling medium can be provided by conducting inspection using a tank or reservoir housing a coupling medium. The probe heads and at least a portion of the test object can be submerged in the coupling medium.

As described herein, various configurations can be used to facilitate surface or volumetric inspection of test objects varying in one or more of length (e.g., longitudinal extent), lateral extent, or profile. Multiple probes can be provided, such as manually or automatically adjusted to provide inspection access to a portion of the object under test, such as via a passage defined by a fixture. An elongate test object can move relative to the passage (either by moving the object relative to the fixture, or vice versa, for example), such as to allow for inspection to occur continuously or at various discrete locations along the longitudinal extent of the object. As mentioned above, such an approach can be carried out by drawing the elongate test object through a stationary fixture or by drawing the fixture along the length of a stationary test object, or a combination of both. Information obtained from the probe can be received by a processor and analyzed to provide inspection results such as imaging, data indicative of dimensional characteristics, or other properties.

Manipulating a test head fixture, such as to translate the fixture relative to an article under test during inspection, can enhance throughput or can provide an NDT inspection system having a reduced footprint as compared to other approaches. For instance, the NDT inspection fixture can function as an end effector of a robotic arm or gantry and can be moved along the elongate test object. Apparatus and techniques, such as shown and described herein, can provide such enhanced throughput at least in part by accommodating elongate test objects that can vary in size or shape by using an adaptable inspection configuration that can be robotically manipulated, such as reducing complexity of systems that may otherwise be used to guide, rotate, or position objects under test having different geometries.

The present inventors have recognized, among other things, that such an adaptable fixture is generally capable of accurately and efficiently inspecting test objects varying in profile, curvature, thickness, and material as well as objects having a non-uniform profile across their entire length. Further, the present inventors have recognized that such a fixture can include multiple NDT inspection probes, such as providing dynamic probe positioning to enhance throughput or otherwise enable inspection of a wide variety of test objects using as few as single probe fixture.

Some elongate test objects, such as a plurality of test objects to be inspected in sequence, can vary from one another such as in size or shape and can include different curvatures along their respective lengths. Generally, these elongate test objects must be inspected manually and such as involving multiple passes. This is due to the importance of establishing the correct position, distance, and angles between each probe and the elongate test object.

The present inventors have conceived of devices and techniques for improving throughput in NDT inspection of elongate test objects. For example, a test head fixture carrying one or more NDT inspection probes can conform to varying shapes and sizes of elongate test objects while being able to reorient such as to accommodate a change in angle or a curvature along the length of the elongate test object. In so doing, probes can be maintained at a specified standoff distance from the test object, minimizing the user interaction involved such as in repositioning the probes to conform to differing profiles. The test head can also adapt, e.g., a gradual change in dimensions along a single elongate test object. The test head fixture can be mounted on a robot or a gantry to move along the full length of the article under test. Also, the test head fixture can be stationary and the article under test can be moved with respect to the test head fixture, such as fed through the test head fixture.

This document describes a non-destructive inspection test head including a first portion and a second portion mechanically coupled with the first portion to support at least two mechanical degrees of freedom relative to the first portion. The second portion can include or use at least two first pinching members to apply force towards each other. The at least two first pinching members, via respective counterforces, can establish a specified first standoff distance between an article under test and a first non-destructive test (NDT) transducer assembly. For example, the at least two second pinching members can be oriented orthogonally with respect to the at least two first pinching members. The at least two second pinch members can be included such as to apply force towards each other to establish a specified second standoff distance between the article under test and a second NDT transducer assembly. Here, the second NDT transducer assembly can be oriented orthogonally with respect to the first NDT transducer assembly.

The second portion can undergo passive reorientation relative to the first portion to maintain the first and second specified standoff distances as the second portion can be translated along the article under test to perform NDT inspection. For example, the two first pinching members can help displace at least one of the test head or the article under test as the second portion is translated along the article. Also, at least one of the test head or the article can be centered, via the maintenance of the specified standoff distances, relative to at least one medial plane of the second portion as the second portion can be translated along the article. In an example, an actuator can be included such as to controllably move that at least one pinching member to facilitate insertion of the article.

The at least two mechanical degrees of freedom include a first rotational degree of freedom and a second rotational degree of freedom. For example, the second rotational degree of freedom can be established orthogonally to the first rotational degree of freedom. Here, the second portion can rotate relative to the first portion about both the first and second rotational degrees of freedom to follow a varying profile of the article as the second portion is translated along the article. Also, the test head can include a third portion mechanically coupled with at least one of the first portion or the second portion, the third portion to support a linear degree of freedom. For example, the third portion can include or can be coupled to a linear actuator included such as to counter a gravitational force on the test head, the countering the gravitational force facilitating passive reorientation as the second portion can be translated along the article under test to perform NDT inspection.

Each of the non-limiting examples described herein can stand on its own, or can be combined in various permutations or combinations with one or more of the other examples.

This Summary is intended to provide an overview of the subject matter of the present patent application. It is not intended to provide an exclusive or exhaustive explanation of the invention. The detailed description is included to provide further information.

### BRIEF DESCRIPTION OF THE FIGURES

In the drawings, which are not necessarily drawn to scale, like numerals can describe similar components in different views. Like numerals having different letter suffixes can represent different instances of similar components. The drawings illustrate generally, by way of example, but not by way of limitation, various embodiments discussed in the present document.

FIG. 1A depicts a perspective view of an example of a test head fixture.

FIG. 1B depicts a side view of an example of a test head fixture.

FIG. 1C depicts a front view of an example of a test head fixture.

FIG. 1D depicts a top view of an example of a test head fixture.

FIG. 1E depicts a bottom view of an example of a test head fixture.

FIG. 2A depicts a detail view of the NDT system shown in FIG. 2B.

FIG. 2B depicts an example of a test head fixture in use in an NDT system.

FIG. 3A depicts an example of a test head fixture conforming to a profile of an article under test.

FIG. 3B depicts a partial view of an example of a test head fixture, showing transducer orientation relative to an article under test.

FIG. 4 is a flowchart describing a method of using a test head fixture to perform NDT of an article under test.

### DETAILED DESCRIPTION

As mentioned above, Non-Destructive Test (NDT) can be used to inspect an object, such as a bar or other structure having a specified profile. The bar or other structure can include metallic or composite material, such as fabricated using one or more of extrusion, rolling, bending, cutting, stamping, or welding, as illustrative examples. The bar or other elongate structure can extend in a longitudinal direction, such as formed as a continuous structure, or having a discrete specified length. A bar or other elongate structure being inspected can vary in size or shape (or both), or can define a change in orientation angle along its length (curve) at any specific point. The angle and radius of curvature may vary from part to part. Because of the complexity of the profiles, such as defining multiple different dimensions and pockets to be inspected, bar or other structures having such complex profiles are usually inspected manually and with multiple passes along the length. Such inspection generally involves a skilled operator manually placing the probe at the proper position, stand-off distance, and angle, which may be important for the desired inspection.

The present inventors have among other things, devised a test head configuration that can reduce the duration consumed by inspection while maintaining desired inspection coverage for bar structures or other structures under test. The test head configuration can include features that conform automatically to various shapes and sizes of structures to under test, while also being able to track (e.g., rotate) to accommodate a change in angle along the length of the bars (e.g., accommodating curvature). The test had can include probes at respective locations that reduce or minimize repositioning as the structure under test passed through the test head (or vice versa). The test structure can be made from any material, such as a material that can be inspected using acoustic inspection, eddy current inspection, or imaging, for example. The test head can automatically adapt such as by conforming to specified exterior dimensions (or features) of the profile of the structure under test. For example, the test head can include rollers or other features (such as slides or plates acting as guides) to accommodate specified overall dimensions of a profile of a structure to be tested, such as automatically orienting inspection probes in a suitable orientation for inspection. The test head can also adapt to gradual change in dimensions as it traverses up to a full length of the bar or other structure under test. The test head can include specified pivot points, such as adapted based on a specified (e.g., minimum) curvature radius and a specified (e.g., maximum) angle. The inspection head can be mounted on a robot or a gantry to move the test head along the structure under test. Alternatively, or in addition, the test head can be stationary, and the structure under test can be moved relative to the test head. The test head can be modified to adapt to any profiles and dimensions. For acoustic inspection, for example, the structure under test can be immersed in a tank to provide a couplant interface between a test head and the structure under test, or couplant can be provided by couplant circulation (e.g., squirter or other nozzle), or otherwise by retention of couplant within a couplant interface region in the test head.

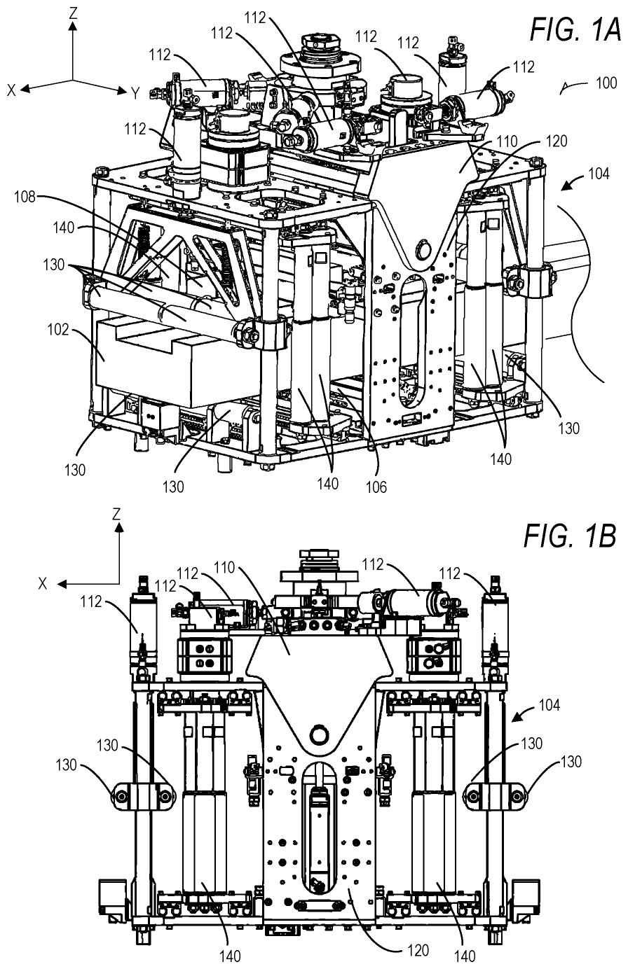

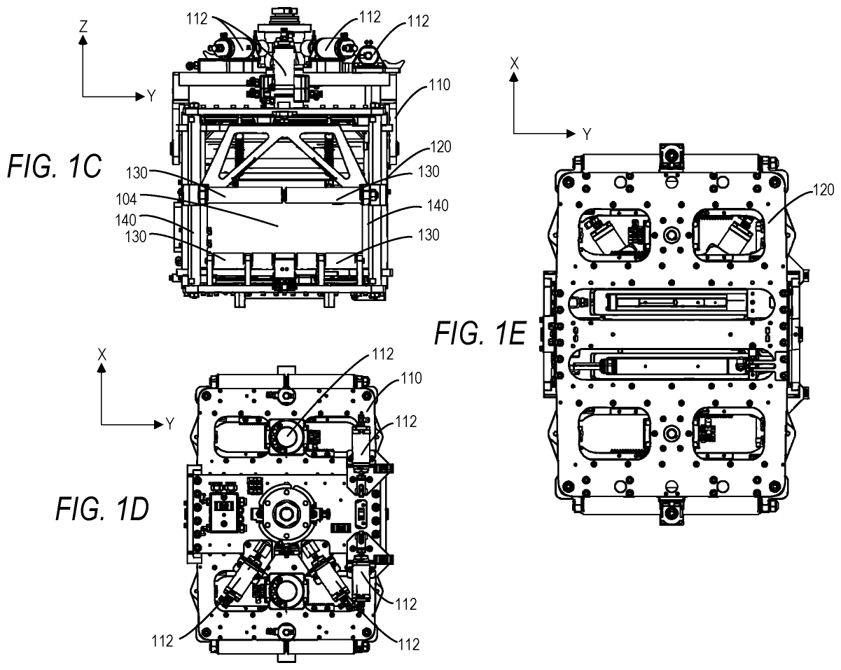

FIG. 1A, FIG. 1B, FIG. 1C, FIG. 1D, and FIG. 1E depict various views of a non-destructive inspection test head. As shown in the perspective view of FIG. 1A, an article under test 102 can be translated relative to the inspection test head, such as at or near an insertion channel 104. For example, the article 102 can be fed into a first end of the test head 100 and out a second end of the test head 100 in the “X” direction. The test head 100 can include a first portion 110, a second portion 120 mechanically coupled with the first portion 110 to support at least two mechanical degrees of freedom relative to the first portion 110. The test head 100 can also include at least two first pinching members 130 included such as to apply force towards each other to establish a specified first standoff distance between an article under test and a first non-destructive test (NDT) transducer assembly 106. For example, the first NDT transducer assembly 106 can be embedded within the test head, such as within the second portion 120. For example, the at least two first pinching members 130 can apply force towards each other towards and opposite the “Z” direction, respectively. Also, one of the at least two first pinching members 130 can remain fixed opposite a corresponding pinching member 130 to receive a force applied therefrom without exerting a counterforce.

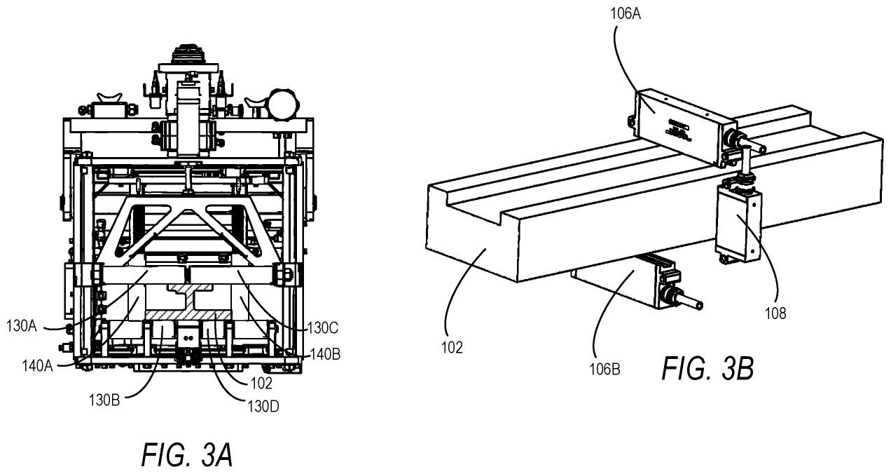

The non-destructive inspection test head 100 can also include at least two second pinching members 140 oriented orthogonally with respect to the at least two first pinching members 130. The at least two second pinch members 140 can act to apply force towards each other to establish a specified second standoff distance between the article under test and a second NDT transducer assembly 108, and the second NDT transducer assembly 108 can be arranged within the second portion such as orthogonally with respect to the first NDT transducer assembly 106 (as depicted in FIG. 3B). The second portion 120 undergo passive reorientation relative to the first portion 110 during inspection such as to maintain the first and second specified standoff distances as the second portion 120 can be translated along the article under test 102 to perform NDT inspection. In an example, either the first or second specified standoff distance can be between about 3 mm and about 10 mm. For example, the first and second standoff distance can be between about 4 mm and about 8 mm.

In an example, the at least two first pinching members 130, the at least two second pinching members 140, or both can include rollers. For example, the rollers include an internal diameter substantially equal to an external diameter of the article under test 102 to be inspected, such as to ensure the at least two pinching members 130, 140 pinch the article under test 102 uniformly. The rollers can include an outer surface with a textured pattern or gripping material such as to assists in providing consistent pinching of the article under test 102. The at least two first pinching members 130 can also be biased toward each other. For example, one or more return springs can bias the at least two first pinching members 130 toward each other. Also, the bias can be applied by one or more actuators 112 such as a motor or pneumatic or hydraulic cylinder. Biasing of the first pinching members 130 can ensure that the first standoff distance is consistently provided between the first NDT transducer assembly 106 and the article under test 102 as the one or more first pinching members 130 can be prevented from relaxing out of the first standoff distance.

In an example, the non-destructive inspection test head 100 can include the one or more actuators 112 to controllably move a corresponding pinching member amongst the at least two first pinching members 130 or amongst the at least two second pinching members 140. In an example, the actuator can be included such as to controllably move that at least one pinching member to facilitate insertion of the article 102. Here, two opposite corresponding pinching members can be moved apart from one another prior to insertion of the article 102 at the first end. Following insertion, the two opposite corresponding pinching members can be moved, such as via the one or more actuators 112, towards each other such as to clamp or grab the article 102. In an example, two opposite corresponding pinching members (such as among the at least two first pinching members 130) or amongst the at least two second pinching members 140) can exert a force on an article 102, the force being between about 1N and about 500N. For example, the force exerted on the article 102 can be between about 20N and about 200N. In an example, alternatively or additionally to the two opposite corresponding pinching members being moved to facilitate insertion of the article 102, an inlet feature, such as a spring loaded or tapered end, can be included at the first end of the test head. For example, the inlet feature can help accept or guide the article 102 upon insertion therein. The inlet feature can accept a force applied thereupon by the article 102 upon insertion such as to displace the inlet feature in order to conform to the profile of the article 102. The inlet feature can be included both sides of the test head 100 such as to allow the article to be inserted into either side of the test head 100.

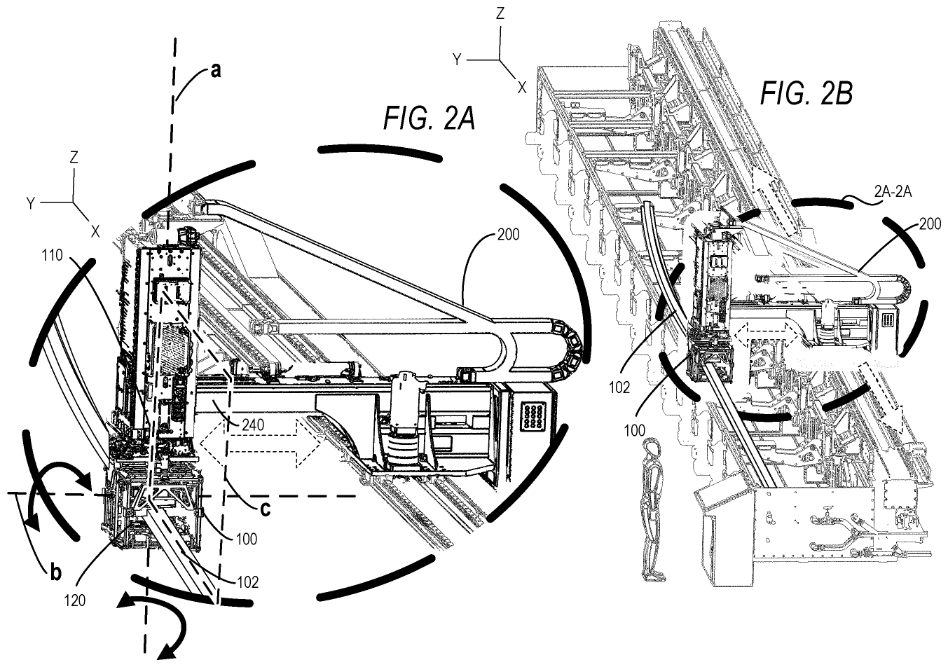

FIG. 2A and FIG. 2B depict an example of a test head fixture in use in an NDT system. In an example, the test head fixture 100 can be mechanically coupled with a manipulator 200 such as a gantry or a robotic manipulator that can be controlled or initiated by a user such as at a user interface. As depicted in FIG. 2B, as the test head 100 is moved relative to the article 102 along the couplant bath 202, such as in the “X” direction, and the test head 100 can passively reorient the second portion 120 such as to follow a profile of the article 102 that varies along a length thereof. For example, the test head can passively follow the curvature of the test object shown in FIG. 2B without the need to actively detect or program for such a curvature. The couplant bath 202 can be at least partially filled with the couplant, such as a water or oil or some other couplant fluid, and the couplant fluid can be supplied such as to flow along the couplant bath 202. For such an application, at least a portion of the test head 100 can be submersible. For example, the test head can be at least partially water-proofed such as by having at least one portion of the test head 100 formed of materials that can allow a couplant fluid to flow there through, such as a water-proofed material, a vacuum jacketing material, or a non-wetting material. Also, the non-destructive inspection test head 100 can also include a port included such as to suppress bubble formation in a region between the article under test and the first and second transducer assemblies when the first and second transducer assemblies can be submerged in a couplant medium.

Generally, the test head 100 can self-center one or more NDT transducer assemblies to specified dimensions of the profile of the article 102. The test head can automatically follow the change in orientation angle along a length (e.g., long dimension) of the article, such as including pivot locations based on a curvature radius or bar angle (or both). The test head 100 can be configured for acoustic inspection (e.g., ultrasonic (UT)), eddy current inspection, or another inspection processes (e.g., imagery). A position or relative motion of the structure under test relative to the test head can be tracked, such as using a stationary encoder or an external encoder (e.g., gantry or robot with motion tracking) can be used.

FIG. 2A depicts a detail view of the NDT system shown in FIG. 2B. In an example, the test head 100 can include or use at least two mechanical degrees of freedom relative to the manipulator 200. In an example, the at least two mechanical degrees of freedom can be a first rotational degree of freedom about a first pivot a (such as the “Z” axis) and a second rotational degree of freedom about a second pivot b (such as the “Y” axis). In an example, the second portion 120 can be included such as to rotate relative to the first portion 110 about one or both the first and second rotational degrees of freedom to follow a varying profile of the article as the second portion 120 can be translated along the article. As such, the second portion 120 of the test head 100 can passively rotate about the first pivot a or the second pivot b such as to change its orientation angle based on the profile of the article 102 in a way that the angle of the test head 100 is pointing tangent to the curve defined by two pinching locations between the first pinching members 130 and the second pinching members 140 (as depicted in FIG. 1A-FIG. 1E), respectively. The pinching action of the first pinching members or the second pinching members can also help guide the test head 100 along the length of the article 102 and can help center the article 102 relative to a medial plane c of the test head 100. For example, the at least two first pinching members displace the test head 100, the article 102, or both as the second portion 120 is translated along the article 102.

In an example, the test head 100 can also include a third portion mechanically coupled with at least one of the first portion 110 or the second portion 120. Here, the third portion can support a linear degree of freedom, such as along the “Y” axis. For example, the test head 100 can include or be attached to a linear extender 240, such as attached at least one of the first portion 110 or the second portion 120. The linear extender 240 can include or use at least one slide mechanism to allow at least one of the first portion 110 or the second portion 120 to passively travel along a line orthogonal to at least one of the first a and second b axes, such as along the “Y” axis. For example, the at least one of the first portion 110 or the second portion 120 can be passively reoriented via at least three mechanical degrees of freedom: a first rotational degree of freedom about the first pivot a, a second rotational degree of freedom about the first pivot b, and a linear degree of freedom along the “Y” axis, such as via the linear extender. Also, the test head 100 can include or can be coupled to at least one of a bias, such as a spring, or an actuator, such as a linear or rotary actuator, applying a force selected to counter a measured or predetermined gravitational force on the test head 100. Here, countering the gravitational force can help facilitate passive reorientation as the second portion 120 is translated along the article 102 to perform NDT inspection.

FIG. 3A depicts a front view of an example of a test head fixture conforming to a profile of an article under test. As shown in FIG. 3A, at least two pinch points can be provided on the article 102 via the pinching members 130 and 140. For example, at least two opposite corresponding second pinching members 140A and 140B can be biased towards each other such as to provide a first pinching point. Also, at least two opposite corresponding second pinching members 130A and 130B (and alternatively or additionally, 130C and 130D) can be biased towards each other such as to provide a second pinching point. Here, the second pinching point can provide force on the article 102 in a direction orthogonal to that of the first pinching point. The first and second pinching points defined above can be used to follow a specific curvature (such as including a plurality of curvatures on multiple different axes) along the length of the curve. In an example, the test head fixture can include or use multiple sets of second pinching members 140 and multiple sets of first pinching members 130, establishing at least three pinching points similar to those defined above, such as to help follow curvature via the at least three pinching points.

FIG. 3B depicts a partial view of an example of a test head fixture, showing transducer orientation relative to an article under test. As shown, at least two NDT transducer assemblies 106 and 108 can be arranged around the article 102, and the first transducer assembly 106 can be arranged orthogonal to the second transducer assembly 106. Also, three or more transducer assemblies, 106A, 106B, and 108A can be included within the second portion of the test head 100.

In an example, the first and second NDT transducer assemblies 106 and 108 can include respective acoustic transducer assemblies. In an example, at least one of the first NDT transducer assembly and the second NDT transducer assembly includes a linear array of acoustic transducers. In an example, at least one of the first NDT transducer assembly and the second NDT transducer assembly includes an eddy current (EC) transducer. Although FIG. 3B depicts a first and a second NDT transducer assembly, there can be more or less than two NDT transducer assemblies. In an example, the transducer assemblies can be implemented as shown in FIG. 3B. That is, at least two transducer assemblies, such as 106A and 106B can be facing each other and located at substantially opposite sides of the test object 102.

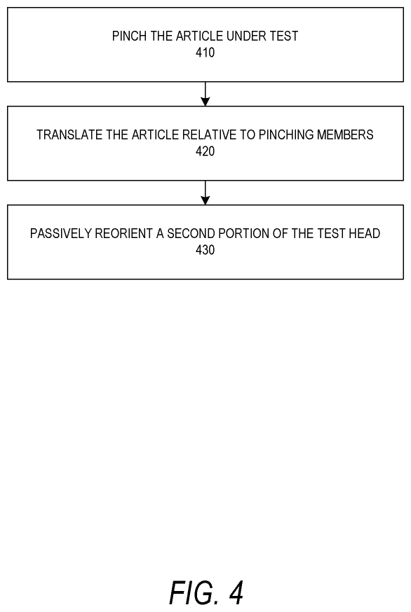

FIG. 4 is a flowchart describing a method of using a test head fixture to perform NDT of an article under test. In an example, at 410, the method can include pinching the article under test between at least two first pinching members and at least two second pinching members. For example, the at least two first pinching members can be provided or obtained such as to apply force towards each other to establish a specified first standoff distance between an article under test and a first non-destructive test (NDT) transducer assembly. In an example, the at least two second pinching members can be arranged such as to be oriented orthogonally with respect to the at least two first pinching members. Also, the method can include apply in a force via the at least two second pinch members towards each other to establish a specified second standoff distance between the article under test and a second NDT transducer assembly oriented orthogonally with respect to the first NDT transducer assembly.

At 420, the method can include translating the article under test along a length thereof and relative to the at least two first pinching members and the at least two second pinching members.

At 430, the method can include passively reorienting a second portion, housing the at least two first pinching members and the at least two second pinching members, relative to a first portion and about at least two mechanical degrees of freedom to maintain the first and second specified standoff distances during the translating.

For example, passively reorienting can include displacing, via the at least two first pinching members, at least one of the test head or the article under test as the second portion during the translating. Also, passively reorienting can include centering at least one of the test head or the article relative to at least one medial plane of the second portion during the translating.

The method can include passively reorienting at least one of the first portion or the second portion, relative to a third portion of the test head, about at least one linear degree of freedom. Also, the method can include countering a gravitational force on the test head to facilitate at least one of the passive reorientations of at least one of the first portion or the second portion during the translation.

The method can include establishing or adjusting, via an actuator, a linear position of at least one pinching member amongst the at least two first pinching members. The method can include rotating the second portion relative to the first portion about both the first and second rotational degrees of freedom to follow a varying profile of the article during the translating.

### NOTES AND EXAMPLES

The following, non-limiting examples, detail certain aspects of the present subject matter to solve the challenges and provide the benefits discussed herein, among others.

Aspect 1 is a non-destructive inspection test head comprising: a first portion: and a second portion mechanically coupled with the first portion to support at least two mechanical degrees of freedom relative to the first portion, the second portion comprising: at least two first pinching members configured to apply force towards each other to establish a specified first standoff distance between an article under test and a first non-destructive test (NDT) transducer assembly: and at least two second pinching members oriented orthogonally with respect to the at least two first pinching members, the at least two second pinch members configured to apply force towards each other to establish a specified second standoff distance between the article under test and a second NDT transducer assembly oriented orthogonally with respect to the first NDT transducer assembly: wherein the second portion is configured for passive reorientation relative to the first portion to maintain the first and second specified standoff distances as the second portion is translated along the article under test to perform NDT inspection.

In Aspect 2, the subject matter of Aspect 1, wherein the at least two first pinching members are configured to displace at least one of the test head or the article under test as the second portion is translated along the article.

In Aspect 3, the subject matter of Aspect 2, wherein at least one of the test head or the article remains centered relative to at least one medial plane of the second portion as the second portion is translated along the article.

In Aspect 4, the subject matter of any of Aspects 1-3, wherein the at least two first pinching members include rollers.

In Aspect 5, the subject matter of any of Aspects 1-4, wherein the at least two first pinching members are biased toward each other.

In Aspect 6, the subject matter of any of Aspects 1-5, comprising an actuator configured to controllably move at least one pinching member amongst the at least two first pinching members.

In Aspect 7, the subject matter of Aspect 6, wherein the actuator is configured to controllably move that at least one pinching member to facilitate insertion of the article.

In Aspect 8, the subject matter of any of Aspects 1-7, wherein the at least two mechanical degrees of freedom include a first rotational degree of freedom.

In Aspect 9, the subject matter of Aspect 8, wherein the at least two mechanical degrees of freedom include a second rotational degree of freedom established orthogonally to the first rotational degree of freedom.

In Aspect 10, the subject matter of Aspect 9, wherein the second portion is configured to rotate relative to the first portion about both the first and second rotational degrees of freedom to follow a varying profile of the article as the second portion is translated along the article.

In Aspect 11, the subject matter of any of Aspects 9-10, comprising a third portion mechanically coupled with at least one of the first portion or the second portion, the third portion to support a linear degree of freedom.

In Aspect 12, the subject matter of Aspect 11, wherein: the first rotational degree of freedom is established around a first axis; the second rotational degree of freedom is established around a second axis; and the linear degree of freedom includes freedom for the at least one of the first portion or the second portion to travel, relative to the third portion, along a line oriented orthogonally at least one of the first axis and the second axis.

In Aspect 13, the subject matter of any of Aspects 11-12, wherein the second portion is configured for reorientation, via the first rotational degree of freedom, the second rotational degree of freedom, and the linear degree of freedom, to maintain the first and second specified standoff distances as the second portion is translated along the article under test to perform NDT inspection.

In Aspect 14, the subject matter of any of Aspects 12-13, wherein the third portion comprises or is coupled to a linear actuator configured to counter a gravitational force on the test head, the countering the gravitational force facilitating passive reorientation as the second portion is translated along the article under test to perform NDT inspection.

In Aspect 15, the subject matter of any of Aspects 12-14, wherein the third portion comprises or is mechanically coupled with at least one of a gantry or a robotic manipulator.

In Aspect 16, the subject matter of any of Aspects 1-15, wherein the first portion is mechanically coupled with at least one of a gantry or a robotic manipulator.

In Aspect 17, the subject matter of any of Aspects 1-16, wherein the second portion is configured for passive reorientation along a curved article under test.

In Aspect 18, the subject matter of any of Aspects 1-17, wherein second portion is configured for passive reorientation along the article under test including following a profile of the article under test that varies along the article under test.

In Aspect 19, the subject matter of any of Aspects 1-18, wherein the first and second NDT transducer assemblies comprise respective acoustic transducer assemblies.

In Aspect 20, the subject matter of any of Aspects 1-19, wherein at least one of the first NDT transducer assembly or the second NDT transducer assembly comprises a linear array of acoustic transducers.

In Aspect 21, the subject matter of any of Aspects 1-20, wherein at least one of the first NDT transducer assembly or the second NDT transducer assembly comprises an eddy current (EC) transducer.

In Aspect 22, the subject matter of any of Aspects 1-21, comprising a bath configured to house a couplant medium in which at least a portion of the test head is submersible.

In Aspect 23, the subject matter of any of Aspects 1-22, comprising a port configured to suppress bubble formation in a region between the article under test and the first and second transducer assemblies when the first and second transducer assemblies are submerged in a couplant medium.

Aspect 24 is a method for non-destructive inspection of an article under test via a test head, the method comprising: pinching the article under test between: at least two first pinching members configured to apply force towards each other to establish a specified first standoff distance between an article under test and a first non-destructive test (NDT) transducer assembly: and at least two second pinching members oriented orthogonally with respect to the at least two first pinching members, the at least two second pinch members configured to apply force towards each other to establish a specified second standoff distance between the article under test and a second NDT transducer assembly oriented orthogonally with respect to the first NDT transducer assembly: translating the article under test along a length thereof and relative to the at least two first pinching members and the at least two second pinching members: and passively reorienting a second portion, housing the at least two first pinching members and the at least two second pinching members, relative to a first portion and about at least two mechanical degrees of freedom to maintain the first and second specified standoff distances during the translating.

In Aspect 25, the subject matter of Aspect 24, comprising displacing, via the at least two first pinching members, at least one of the test head or the article under test as the second portion during the translating.

In Aspect 26, the subject matter of Aspect 25, comprising centering at least one of the test head or the article relative to at least one medial plane of the second portion during the translating

In Aspect 27, the subject matter of any of Aspects 24-26, comprising establishing or adjusting, via an actuator, a linear position of at least one pinching member amongst the at least two first pinching members.

In Aspect 28, the subject matter of any of Aspects 24-27, wherein the at least two mechanical degrees of freedom include a first rotational degree of freedom.

In Aspect 29, the subject matter of Aspect 28, wherein the at least two mechanical degrees of freedom include a second rotational degree of freedom established orthogonally to the first rotational degree of freedom.

In Aspect 30, the subject matter of Aspect 29, comprising rotating the second portion relative to the first portion about both the first and second rotational degrees of freedom to follow a varying profile of the article during the translating.

In Aspect 31, the subject matter of any of Aspects 29-30, comprising passively reorienting at least one of the first portion or the second portion, relative to a third portion, about at least one linear degree of freedom.

In Aspect 32, the subject matter of Aspect 31, comprising countering a gravitational force on the test head to facilitate at least one of the passive reorientations of at least one of the first portion or the second portion during the translation.

In Aspect 33, the subject matter of any of Aspects 24-32, comprising submersing the test head in a couplant fluid.

In Aspect 34, the subject matter of Aspect 33, comprising suppressing, via a fluid port, bubble formation in a region between the article under test and the first and second transducer assemblies during the submersing of the test head.

Aspect 35 is a non-destructive inspection test head comprising: a first portion: a second portion including at least one non-destructive test (NDT) transducer assembly, the second portion configured to rotate relative to the first portion via a first pivot point arranged about a first axis and a second pivot point arranged about a second axis orthogonal to the first axis: and two or more pinching members coupled to the second portion, the pinching members arranged to apply force towards each other and towards an insertion channel extending through the second portion: wherein: the pinching members are configured to maintain a specified standoff distance between a test object passing through the insertion channel: and the second portion is configured to passively rotate relative to the first portion via both the first and second pivot points to follow a varying curvature of an article under test passing through the insertion channel.

In Aspect 36, the subject matter of Aspect 35, wherein the two or more pinching members are configured to displace at least one of the test head or the article under test as the second portion is translated along the article.

In Aspect 37, the subject matter of any of Aspects 35-36, wherein the two or more first pinching members include rollers.

In Aspect 38, the subject matter of any of Aspects 35-37, wherein the two or more first pinching members are biased toward each other.

In Aspect 39, the subject matter of any of Aspects 35-38, comprising an actuator configured to controllably move at least one pinching member amongst the two or more pinching members.

In Aspect 40, the subject matter of Aspect 39, wherein the actuator is configured to controllably move that at least one pinching member to facilitate insertion of the article.

In Aspect 41, the subject matter of any of Aspects 35-40, comprising: a linear extender attached to at least one of the first portion or the second portion, the linear extender at least one slide mechanism configured to allow at least one of the first portion or the second portion to travel along a line orthogonal to at least one of the first and second axes: wherein the second portion is configured to passively rotate relative to the first portion about the first and second axes and the second portion is configured to passively travel along the line orthogonal to both the first and second axes to follow a curvature of the article under test passing through the insertion channel.

In Aspect 42, the subject matter of Aspect 41, comprising at least one actuator configured to provide a force on at least a portion of the test head along the line orthogonal to both the first and second axes, the force selected to counter a gravitational force on the test head and to suspend the frame enabling the free travel along the line to follow a varying profile shape of a test object passing through the insertion channel.

In Aspect 43, the subject matter of any of Aspects 35-42, wherein the first portion is mechanically coupled with at least one of a gantry or a robotic manipulator.

In Aspect 44, the subject matter of any of Aspects 35-43, wherein the first and second transducer assemblies comprise respective acoustic transducer assemblies.

In Aspect 45, the subject matter of any of Aspects 35-44, wherein at least one of the first NDT transducer assembly or the second NDT transducer assembly comprises a linear array of acoustic transducers.

In Aspect 46, the subject matter of any of Aspects 35-45, wherein at least one of the first NDT transducer assembly or the second NDT transducer assembly comprises an eddy current (EC) transducer.

In Aspect 47, the subject matter of any of Aspects 35-46, comprising a bath configured to house a couplant medium in which at least a portion of the test head is submersible.

In Aspect 48, the subject matter of any of Aspects 35-47, comprising a port configured to suppress bubble formation in a region between the article under test and the first and second transducer assemblies when the first and second transducer assemblies are submerged in a couplant medium.

Aspect 49 is at least one machine-readable medium including instructions that, when executed by processing circuitry, cause the processing circuitry to perform operations to implement of any of Aspects 1-48.

Aspect 50 is an apparatus comprising means to implement of any of Aspects 1-48.

Aspect 51 is a system to implement of any of Aspects 1-48.

Aspect 52 is a method to implement of any of Aspects 1-48.

The above Detailed Description can include references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that can include elements in addition to those listed after such a term in a claim are still deemed to fall within the scope of that claim.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” can include “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that can include elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) can be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1.-48. (canceled)

49. A non-destructive inspection test head comprising:
a first portion; and
a second portion mechanically coupled with the first portion to support at least two mechanical degrees of freedom relative to the first portion, the second portion comprising:
at least two first pinching members configured to apply force towards each other to establish a specified first standoff distance between an article under test and a first non-destructive test (NDT) transducer assembly; and
at least two second pinching members oriented orthogonally with respect to the at least two first pinching members, the at least two second pinch members configured to apply force towards each other to establish a specified second standoff distance between the article under test and a second NDT transducer assembly oriented orthogonally with respect to the first NDT transducer assembly.

50. The test head of claim 49, wherein the second portion is configured for passive reorientation relative to the first portion to maintain the first and second specified standoff distances as the second portion is translated along the article under test to perform NDT inspection.

51. The test head of claim 49, wherein the at least two first pinching members are configured to displace at least one of the test head or the article under test as the second portion is translated along the article.

52. The test head of claim 51, wherein at least one of the test head or the article remains centered relative to at least one medial plane of the second portion as the second portion is translated along the article.

53. The test head of claim 49, wherein the at least two first pinching members are biased toward each other.

54. The test head of claim 49, wherein the at least two mechanical degrees of freedom including a first rotational degree of freedom and a second rotational degree of freedom established orthogonally to the first rotational degree of freedom.

55. The test head of claim 54, wherein the second portion is configured to rotate relative to the first portion about both the first and second rotational degrees of freedom to follow a varying profile of the article as the second portion is translated along the article.

56. The test head of claim 54, comprising a third portion mechanically coupled with at least one of the first portion or the second portion, the third portion to support a linear degree of freedom.

57. The test head of claim 56, wherein:
the first rotational degree of freedom is established around a first axis;
the second rotational degree of freedom is established around a second axis; and
the linear degree of freedom includes freedom for the at least one of the first portion or the second portion to travel, relative to the third portion, along a line oriented orthogonally at least one of the first axis and the second axis.

58. The test head of claim 57, wherein the second portion is configured for reorientation, via the first rotational degree of freedom, the second rotational degree of freedom, and the linear degree of freedom, to maintain the first and second specified standoff distances as the second portion is translated along the article under test to perform NDT inspection.

59. The test head of claim 57, wherein the third portion comprises or is coupled to at least one of a bias or an actuator, the bias or actuator configured to counter a gravitational force on the test head, the countering the gravitational force facilitating passive reorientation as the second portion is translated along the article under test to perform NDT inspection.

60. The test head of claim 49, wherein second portion is configured for passive reorientation along the article under test including following a profile of the article under test that varies along the article under test.

61. The test head of claim 49, wherein the first and second NDT transducer assemblies comprise respective acoustic transducer assemblies including at least one of a linear array of acoustic transducers or an eddy current (EC) transducer.

62. A method for non-destructive inspection of an article under test via a test head, the method comprising:
pinching the article under test between:
at least two first pinching members configured to apply force towards each other to establish a specified first standoff distance between an article under test and a first non-destructive test (NDT) transducer assembly; and
at least two second pinching members oriented orthogonally with respect to the at least two first pinching members, the at least two second pinch members configured to apply force towards each other to establish a specified second standoff distance between the article under test and a second NDT transducer assembly oriented orthogonally with respect to the first NDT transducer assembly;
translating the article under test along a length thereof and relative to the at least two first pinching members and the at least two second pinching members; and
passively reorienting a second portion, housing the at least two first pinching members and the at least two second pinching members, relative to a first portion and about at least two mechanical degrees of freedom to maintain the first and second specified standoff distances during the translating.

63. The method of claim 62, comprising displacing, via the at least two first pinching members, at least one of the test head or the article under test as the second portion during the translating.

64. The method of claim 63, comprising centering at least one of the test head or the article relative to at least one medial plane of the second portion during the translating.

65. A non-destructive inspection test head comprising:
a first portion;
a second portion including at least one non-destructive test (NDT) transducer assembly, the second portion configured to rotate relative to the first portion via a first pivot point arranged about a first axis and a second pivot point arranged about a second axis orthogonal to the first axis; and
two or more pinching members coupled to the second portion, the pinching members arranged to apply force towards each other and towards an insertion channel extending through the second portion;
wherein:
the pinching members are configured to maintain a specified standoff distance between a test object passing through the insertion channel; and
the second portion is configured to passively rotate relative to the first portion via both the first and second pivot points to follow a varying curvature of an article under test passing through the insertion channel.

66. The test head of claim 65, wherein the two or more pinching members are configured to displace at least one of the test head or the article under test as the second portion is translated along the article.

67. The test head of claim 65, wherein the two or more first pinching members include rollers.

68. The test head of claim 65, wherein the two or more first pinching members are biased toward each other.
